(19) United States
(12) Patent Application Publication
(10) Pub. No.: US 2002/0013929 A1
(43) Pub. Date: Jan. 31, 2002

(54) Error correction for system interconnects

(75) Inventor: Mark A. Maciver, Renfrewshire (SE)

Correspondence Address: Blanche E. Schiller, Esq., HESLIN & ROTHENBERG, P.C., 5 Columbia Circle, Albany, NY, 12203, US

(73) Assignee: International Business Machines Corporation, Armonk, NY

(21) Appl. No.: 09/838,074

(22) Filed: Apr. 19, 2001

(30) Foreign Application Priority Data
Apr. 25, 2000 (GB) 0009804.6

(51) Int. Cl. G06F 11/00

(52) U.S. Cl. 714/800

(57) ABSTRACT

A system for error detection and correction in an interface between two portions of a data processing system is disclosed. The system includes a parity generator in a first portion of the data processing system. The parity generator generates parity bits corresponding to substantially the entirety of bits contained in the interface. The data and parity bits are transmitted across the interface. The system also includes a parity check in a second portion of the data processing system, for checking that the parity bits correspond to the bits for which parity was encoded. An error correction circuit is also provided, in a second portion of the data processing system, for correcting errors in the bits for which parity was encoded. An indication is optionally provided to the data processing system of corrected errors.

### PRIOR FOREIGN APPLICATION

This application claims priority from United Kingdom patent application number 0009804.6, filed Apr. 25, 2000, which is hereby incorporated herein by reference in its entirety.

### TECHNICAL FIELD

The present invention relates to error detection and correction in data processing systems where the error correction is carried out on a chip, package, card or system level.

### BACKGROUND ART

Error detection and correction have been employed on memory subsystems in data processing equipment before in such form as Memory Parity, Error Checking and Correction, Chipkill technology and the like. Memory Parity can only detect errors when there is an odd number of bit errors. It cannot detect an even number of bit errors, nor can it correct any number of bit errors, whether odd or even. Error Checking and Correcting (ECC) operates within a Dual Inline Memory Module (DIMM) to detect and correct a single bit error within the memory module. Chipkill technology can compensate for multi-bit errors from any portion of a single memory chip. These technologies protect against faults internal to the memory modules and do not extend coverage to the system buses or connectors. Such technologies are usually employed initially on servers where high reliability is essential, migrating to personal computers once the cost reduces.

U.S. Pat. No. 5,537,425 discloses a parity error detection system for a memory controller which can detect single and double bit errors. The system relies on the address and data buses being defined so that errors on these buses can be detected. It does not correct errors on other lines of a system bus or a system interconnection, nor does it provide any error correction. The technique used is specific to memory controller, Direct Access Storage devices or tape storage or the like.

U.S. Pat. No. 3,810,577 discloses a built-in test system that detects parity errors on data and address lines. Processor modules then participate in a handshake process in order to communicate the errors and then bypass the error. The system provides error detection for the address and data buses only and relies on the particular processors being configured for the system.

IBM Technical Disclosure Bulletin v.34, n.10b, pp.196-7 discloses the use of parity applied to an address and a data bus. One parity bit is specified for each data or address bus byte together with a parity control signal. Odd number of bit errors can be detected, but cannot be corrected.

A significant number of manufacturing and customer problems relate to intermittent or hard faults associated with system interconnects. These connections can be at the component or card level such as, for example, solder connection problems or they can be at the system-level, such as, for example, mating connector pins. These problems add a significant operating cost to business by way of warranty costs, yield and reliability, that is presently considered to be unavoidable.

So it would be desirable to provide a mechanism that reduces or removes the effects of these intermittent or hard faults in data processing systems.

### SUMMARY OF THE INVENTION

Accordingly, an aspect of the present invention provides a method of providing error detection and correction in an interface between two portions of a data processing system, the method comprising: generating, in a first portion of the data processing system, parity bits corresponding to substantially the entirety of bits contained in the interface; transmitting across the interface the parity bits together with the entirety of bits contained in the interface; testing, in a second portion of the data processing system, that the parity bits correspond to the bits for which parity was encoded; and detecting and correcting, in a second portion of the data processing system, errors in the bits for which parity was encoded.

The advantages of the present invention include the protection of the integrity of control and status lines in an interface, as well as the protection of data and address lines.

In one embodiment, an indication is provided to the data processing system of corrected errors. Although the errors will have been corrected by an aspect of the present invention, the provision of an indication that there were errors can be useful to indicate the level of, and any degradation in, system performance.

An aspect of the present invention also provides a system for error detection and correction in an interface between two portions of a data processing system, the system comprising: a parity generator, in a first portion of the data processing system, for generating parity bits corresponding to substantially the entirety of bits contained in the interface; an interface for transmitting the data bits and the parity bits; a parity checker, in a second portion of the data processing system, for checking that the parity bits correspond to the bits for which parity was encoded; and an error correction circuit, in a second portion of the data processing system, for correcting errors in the bits for which parity was encoded.

### BRIEF DESCRIPTION OF THE DRAWINGS

Embodiments of the invention will now be described, by way of example, with reference to the accompanying drawings, in which:

FIG. 1 is a block diagram of a prior art computer system in which the present invention may be used;

FIG. 2 is a block diagram of a system according to an aspect of the present invention;

FIG. 3 is a schematic diagram of the parity generator of FIG. 2;

FIG. 4 is a schematic diagram of the parity checker of FIG. 2; and

FIG. 5 is a schematic diagram of the error correction circuit of FIG. 2.

### BEST MODE FOR CARRYING OUT THE INVENTION

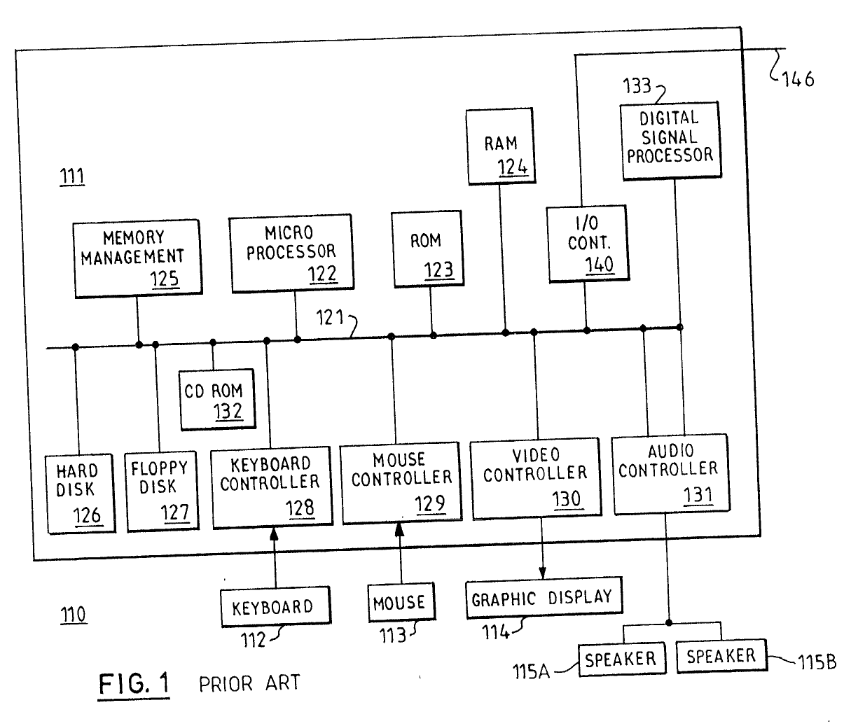

Referring firstly to FIG. 1, a prior art computer 110, comprising a system unit 111, a keyboard 112, a mouse 113 and a display 114 are depicted in block diagram form. The system unit 111 includes a system bus or plurality of system buses 121 to which various components are coupled and by which communication between the various components is accomplished. The microprocessor 122 is connected to the system bus 121 and is supported by read only memory (ROM) 123 and random access memory (RAM) 124 also connected to system bus 121. In many typical computers the microprocessors include the Intel 386, 486 or Pentium microprocessors (Intel and Pentium are trademarks of Intel Corp.). However, other microprocessors including, but not limited to, Motorola's family of microprocessors such as the 68000, 68020 or the 68030 microprocessors and various Reduced Instruction Set Computer (RISC) microprocessors such as the PowerPC chip manufactured by IBM, or other microprocessors from Hewlett Packard, Sun, Motorola and others may be used in the specific computer.

The ROM 123 contains among other code the Basic Input-Output system (BIOS) which controls basic hardware operations such as the interaction between the CPU and the disk drives and the keyboard. The RAM 124 is the main memory into which the operating system and application programs are loaded. The memory management chip 125 is connected to the system bus 121 and controls direct memory access operations including, passing data between the RAM 124 and hard disk drive 126 and floppy disk drive 127. The CD ROM 132 also coupled to the system bus 121 is used to store a large amount of data, e.g. a multimedia program or presentation. CD ROM 132 may be an external CD ROM connected through an adapter card or it may be an internal CD ROM having direct connection to the motherboard.

Also connected to this system bus 121 are various I/O controllers: the keyboard controller 128, the mouse controller 129, the video controller 130 and the audio controller 131. As might be expected, the keyboard controller 128 provides the hardware interface for the keyboard 112, the mouse controller 129 provides the hardware interface for mouse 113, the video controller 130 is the hardware interface for the display 114, and the audio controller 131 is the hardware interface for the speakers 115a and 115b. An I/O controller 140 such as a Token Ring adapter card enables communication over a network 146 to other similarly configured data processor systems. These I/O controllers may be located on the motherboard or they may be located on adapter cards which plug into the motherboard, either directly or into a riser card. The adapter cards may communicate with the motherboard using a PCI interface, an ISA or EISA interface or other interfaces.

An aspect of the present invention is the use of circuitry to detect and correct system-wide errors on interconnecting address, data and control lines. Such an arrangement may be integrated into a comprehensive and fault-tolerant system management architecture.

Many forms of error detection and correction have been implemented in the communications industry to separate the desired signal from background noise. One of the methods that can be applied to a computer server or personal computer architecture in the context of hardware detection and correction is the use of a Hamming code. The Hamming code employs additional bits in a communication channel to encode parity. Hamming codes are described in “Hamming, R. W., Error Detecting and Error Correcting Codes, Bell System Technical Journal, 29, 147-160 (1950)”, which is hereby incorporated herein by reference in its entirety. The parity signals can reconstruct the correct information prior to further processing. The number of parity bits increases with the number of errors to be detected or detected and corrected.

The proposed hardware implementation adds additional parity lines to the address, data and other signals to correct a single or multiple bit error. Advantageously, the parity generator circuit and the parity checker circuit are designed into silicon at each end of a signal link. The parity generation and checking is transparent to the main function of the silicon and corrects any single fault on any of the interconnections at chip, package, card or system-level.

Referring again to FIG. 1, the error correction of the present invention may be employed at a component level in memory chips affixed to the RAM 124 or ROM 123 or in the processing chips associated with other elements of the system of FIG. 1, such as the microprocessor 122, memory management 125, hard disk 126, floppy disk 127, keyboard controller 128, mouse controller 129, video controller 130, audio controller 131, CDROM 132, Digital Signal Processor 133 or I/O controller 140. Components within each of these elements may use the present invention so as to detect and correct errors in their connection to the circuit card or cards associated with that element. In order to implement an aspect of the invention one or both of either the parity generator or parity checker is to be implemented within the component itself and one or both of either the parity generator or parity checker is to be implemented on the circuit card or cards associated with the element. In this implementation, the connections at a component level are protected against certain errors, both intermittent errors and hard errors. The present invention not only protects address and data lines, but also protects control, status and any other signal lines in an interface.

Additionally, the present invention may be employed for the interface connections from the keyboard controller 128 to the keyboard 112, the mouse controller 129 to the mouse 113, the video controller 130 to the graphic display 114 and the audio controller 131 to the speakers 115A, 115B (where the connection to the speakers is a digital one).

The error correction of the present invention may also be employed at a system level in the interface between each of the elements of the system mentioned above and their common interconnecting bus. The elements within the system may use the present invention so as to detect and correct errors in their connection to the system itself and/or to other elements of the system. In order to implement an aspect of the invention one or both of either the parity generator or parity checker is to be implemented within the element itself. In one embodiment, the parity generator or parity checker is implemented within each of the elements and data transfers between each of the elements have their errors, both intermittent and hard, corrected by the transfer of parity information from the source element to the destination element. In this embodiment, each of the elements includes the desired parity generation and/or checking circuitry. In a variation of this embodiment, if one or more of the elements does not include such circuitry, then the additional parity bits are discarded and the system works normally, without modification, although the advantages of error correction of the present invention are not obtained. However, no data is lost. In another embodiment of the present invention, the system bus itself also has a parity generator and checker circuit and the transfer from the data source to the system bus is treated as one interface and the transfer from the system bus to the data destination is treated as another interface.

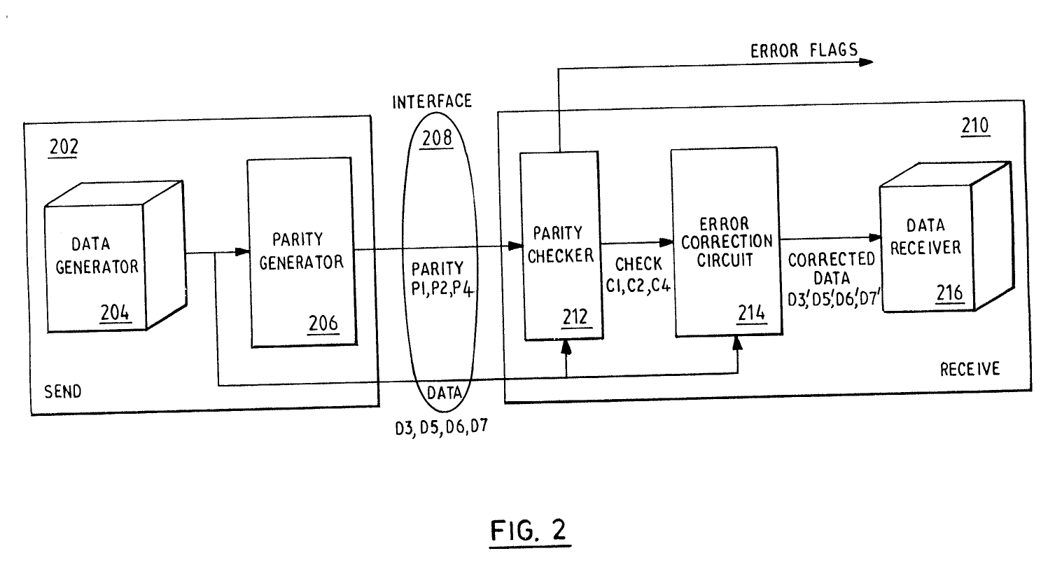

FIG. 2 shows a block diagram of a system including the present invention. In the sending component or element 202, data is generated in block 204. In a prior art system that data would be sent directly over interface 208 to block 216 of the receiving component or element. Errors introduced by the interface 208 are not detected or corrected. In an aspect of the present invention, the data generated by the generating block 204 is sent directly over interface 208 to the parity checker 212 and the error correction circuit 214. The data from the sending component is also sent to the parity generator 206 in the sending component or element. Parity is generated in the parity generator 206 and transmitted across the interface 208 to the parity checker 212 in the receiving component 210.

In FIG. 2, the data is represented by D3, D5, D6 and D7. The numbers represents the typical locations in an encoded word. Similarly, the Parity bits are P1, P2 and P4 for the example shown. The transmitted signal usually separates the parity bits in this way and embeds them within the data word (i.e. P1, P2, D3, P4, D5, D6, D7). However, the present invention does not require the parity bits to be located in these locations.

In the receiving component 210, the parity checker 212 combines the received parity with the received data to generate check bits. These check bits are all zero if the received parity corresponds to the received data. If an error has occurred in transmission of the data or the parity across the interface, one or more of the check bits will be non-zero. The error correction circuit 214 combines the check bits with the received data to correct the error in the data. The corrected data is then passed on to block 216.

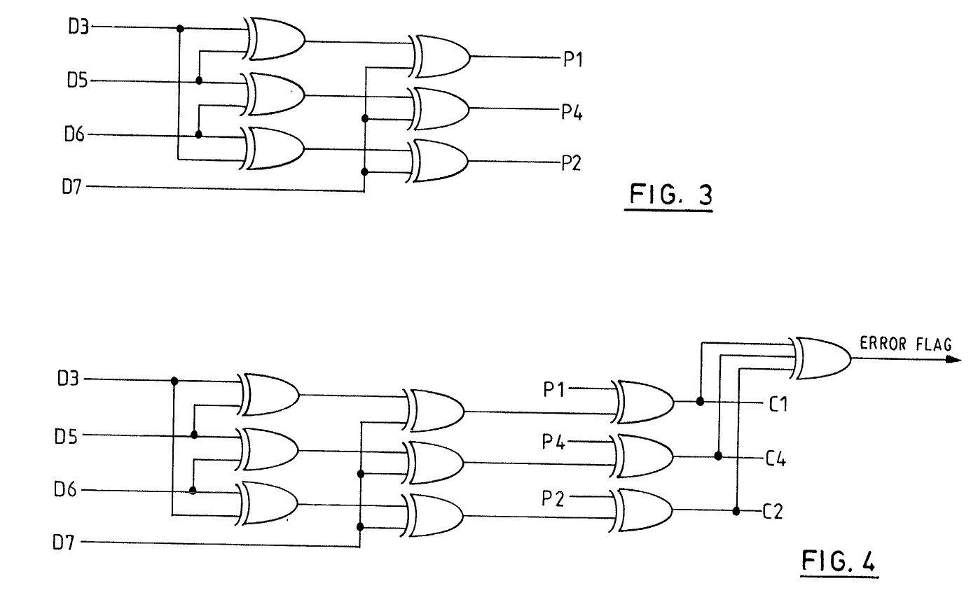

The implementation of the parity generator and parity checkers are straightforward in silicon design. FIG. 3 shows a typical implementation of a parity generator circuit for single bit error correction for 4 data bit lines. Parity bits P1, P2 and P4 are generated from the transmitted data bits according to the following formulae:

P1=D3⊕D5⊕D7

P2=D3⊕D6⊕D7

P4=D5⊕D6⊕D7

where ⊕ represents the logical Exclusive-Or function (a circled plus sign).

FIG. 4 shows a typical implementation of a parity checker circuit for single bit error correction for 4 data bit lines, that is, a checker which is complementary to the generator of FIG. 3. Check bits C1, C2 and C4 are generated from the received data and parity bits according to the following formulae:

C1=P1⊕D3⊕D5⊕D7

C2=P2⊕D3⊕D6⊕D7

C4=P4⊕D5⊕D6⊕D7

Note that both encoding and decoding is performed by asynchronous gates and does not require additional clock cycles. The data is generated asynchronously and latching of both the data and parity information is the responsibility of the sending or receiving components according to the timings of the particular interface in use.

If any of the check bits are set, then an error has occurred in transmission of the data or the parity across the interface. The position of the error within the data and parity word can be determined from the resulting Binary word as {C4 C2 C1}.

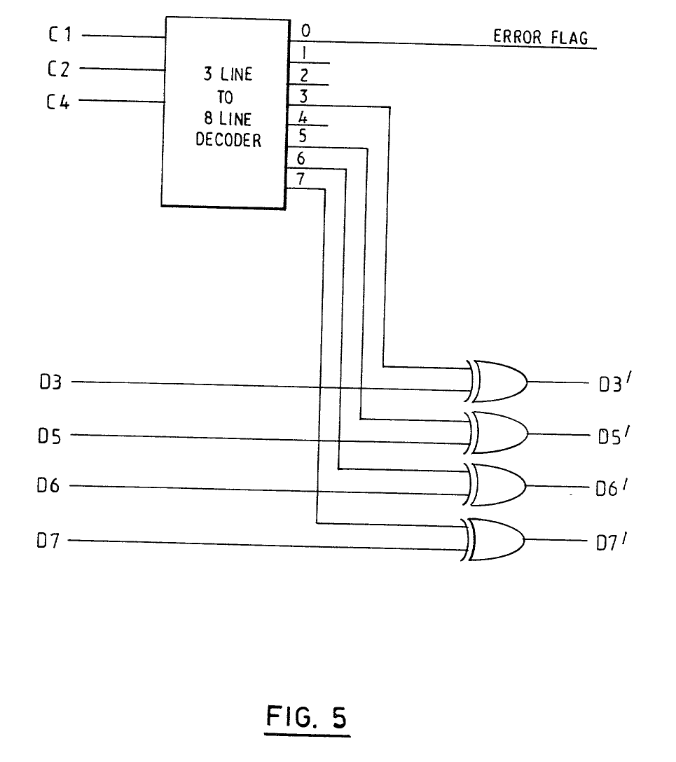

FIG. 5 shows a typical implementation of the error correction circuit 214 for single bit error correction for 4 data bit lines. Check bits C1, C2, C4 are decoded in a 3 line to 8 line decoder to produce an output that indicates which bit of the data and parity word has an error. If {C4 C2 C1}=‘000’, then there are no errors, all of the outputs of the decoder are set to zero except the “0” output which may be used as a positive indication that there are no errors. Data bits D3, D5, D6, D7 are unchanged by the Exclusive-Or gates and are transmitted unchanged as corrected data D3′, D5′, D6′, D7′. If {C4 C2 C1} is non-zero, then there are errors and the “0” output will be set to zero indicating that there is an error to be corrected. If the error is in one of the parity bits, P1, P2 or P4, then the data integrity is maintained and so data bits D3, D5, D6, D7 are unchanged by the Exclusive-Or gates and are transmitted unchanged as corrected data D3′, D5′, D6′, D7′. If the error is in one of the data bits, D3, D5, D6 or D7, then there has been a data error and so a data bit which is in error is inverted by the Exclusive-Or gates and the corrected data appears as D3′, D5′, D6′, D7′.

In a first example, if {C4 C2 C1}=‘100’ then the error has occurred at position four (4). This corresponds to parity bit P4 and the data (D3 D5 D6 D7) is unaffected, that is, it is the parity bit that has been incorrectly received.

In a second example, if {C4 C2 C1}=‘101’ then the error has occurred at position five (5). Thus, the data (D3 D5 D6 D7) has a problem at data bit D5. D5 is then inverted to its correct state in order to correct the error.

In order to further explain the implementation of the present invention, an example of data of ‘1001’ being generated will be considered and the consequences of various errors caused by transmission across the interface 208.

As a first step, Parity Bits are calculated:

| D3 | D5 | D6 | D7 | Parity: => | P1 | P2 | P1 |
|---|---|---|---|---|---|---|---|
| 1 | 0 | 0 | 1 | | 1 | 0 | 0 |

On receipt of the data and parity bits, the parity checker checks the received data and parity and determines whether there is an error and the location of the error if one is present:

| | P1 | P2 | D3 | P4 | D5 | D6 | D7 | C4 | C2 | C1 | |
|---|---|---|---|---|---|---|---|---|---|---|---|
| Correct | 0 | 0 | 1 | 1 | 0 | 0 | 1 | 0 | 0 | 0 | No errors |
| Data | | | | | | | | | | | flagged |
| and | | | | | | | | | | | |
| Parity | | | | | | | | | | | |
| Error | 0 | 0 | 1 | 0 | 0 | 0 | 1 | 1 | 0 | 0 | Error at |
| at P4 | | | | | | | | | | | P4 (‘100’) |
| Error | 0 | 0 | 1 | 1 | 1 | 0 | 1 | 1 | 0 | 1 | Error at |
| at | | | | | | | | | | | D5 (‘101’) |
| D5 | | | | | | | | | | | |

In addition to single bit error correction, the error detection signal may be used to flag a corrected error (which has no system impact) to the system management. The presence of an error which has been corrected can be determined in the parity checker 212 by ORing the check bits C1, C2 and C4 together to indicate a corrected error if any one of C1, C2 or C4 are set. The presence of an error which has been corrected can also be determined in the error correction circuit 214 by using the “0” output of the 3 to 8 line decoder as an indication that no errors have been corrected.

For the example shown (Hamming distance of 3), any received data that differs from a valid code by one bit is assumed to need correction. In some cases, double-bit errors will be interpreted incorrectly and ‘corrected’ with the wrong data. In other cases, the received data will not be close to any valid code and the Check bits can be used to detect the error.

In the embodiment described herein having a Hamming distance of 3, the location of double-bit errors cannot be identified as a Hamming distance of three can only locate single-bit errors. For all double-bit errors to be detected successfully, the single-bit error-correction is to be disabled. Thus, the check flags will identify all single-bit and double-bit uncorrected errors if any combination of these flags is set.

Alternative coding algorithms also exist that could perform an equivalent function. Table 1 below illustrates the number of data lines that can have one bit errors corrected by any given number of parity lines for the Hamming code. The Hamming code has been used as an example of an algorithm that can correct a given number of lines. Table 1 illustrates the additional overhead due to single bit error correction for the Hamming code algorithm as applied to the example of FIG. 1. This example shows the coding and decoding sequence (XOR) for four signal lines. Error correction uses the C1, C2, C4 data to correct the y data (or parity) bit before further processing. The flags can also be used by the system management ion for further processing.

1 - System level single-bit error correction

| | | Percentage |
|---|---|---|
| Protected Data | Number of Parity | Connection |
| Lines | Lines | Increase |
| 4 | 3 | 75% |
| 11 | 4 | 36% |
| 26 | 5 | 19% |
| 57 | 6 | 10% |
| 120 | 7 | 6% |
| 247 | 8 | 3% |

Whilst the examples in the above table will not be described in detail as they merely extend the principles applied above, two further examples will be given of the formulae used for implementation of 11 data bit plus 4 parity bits and 26 data bits plus 5 parity bits.

In an example for 11 data bits, the 4 parity bits are numbered P1, P2, P4 and P8. The data bits are inserted between these positions (ie. D3, D5-D7 and D9-D15). The formulae used to calculate the parity bits are:

P1=D5⊕D7⊕D9⊕D11⊕D13⊕D15

P2=D3⊕D6⊕D7⊕D10⊕D11⊕D14⊕D15

P4=D6⊕D7⊕D12⊕D13⊕D14⊕D15

P8=D9⊕D10⊕D11⊕D12⊕D12⊕D14⊕D15

C1=P1⊕D3⊕D5⊕D7⊕D9⊕D11⊕D13⊕D15

C2=P2⊕D3⊕D6⊕D7⊕D10⊕D11⊕D14⊕D15

C4=P4⊕D5⊕D6⊕D7⊕D12⊕D13⊕D14⊕D15

C4=P8⊕D9⊕D10⊕D11⊕D12⊕D13⊕D14⊕D15

In an example for 26 data bits, the 5 parity bits are numbered P1, P2, P4, P8 and P16. The data bits are inserted between these positions (ie. D3, D5-D7, D9-D15 and D17-D31). The formulae used to calculate the parity bits are:

P1=D3⊕D5⊕D7⊕D9⊕D11⊕D13⊕D15⊕D17⊕D19αD21⊕D23⊕D25⊕D27⊕D29⊕D31

P2=D3⊕D6⊕D7⊕D10⊕⊕D11⊕D14⊕D15⊕D18⊕D19⊕D22⊕D23⊕D26⊕D27⊕D30⊕D31

P4=D5⊕D6⊕D7⊕D12⊕D13⊕D14⊕D15⊕D20⊕D21⊕D22⊕D23⊕D28⊕D29⊕D30⊕D31

P8=D9⊕D10⊕D11⊕D12⊕D13⊕D14⊕D15⊕D24⊕D25⊕D26⊕D27⊕D28⊕D29⊕D30⊕D31

P16=D17⊕D18⊕D19⊕D20⊕D21⊕D22⊕D23⊕D24⊕D25⊕D26⊕D27⊕D28⊕D29⊕D30⊕D31

C1=P1⊕D3⊕D5⊕D7⊕D9⊕D11⊕D13⊕D15⊕D17⊕D19⊕D21⊕D23⊕D2⊕D27⊕D29⊕D31

C2=P2⊕D3⊕D6⊕D7⊕D10⊕D11⊕D14⊕D15⊕D18⊕D19⊕D22⊕D23⊕D26⊕D27⊕D30⊕D31

C4=P4⊕D5⊕D6⊕D7⊕D12⊕D13⊕D14⊕D15⊕D20⊕D21⊕D22⊕D23⊕D28⊕D29⊕D30⊕D31

C8=P8⊕D9⊕D10⊕D11⊕D12⊕D13⊕D14⊕D15⊕D24⊕D25⊕D27⊕D28⊕⊕D29⊕D30⊕D3

C16=P16⊕P16⊕D17⊕D18⊕D19⊕D20⊕D21⊕D22⊕D23⊕D24⊕D25⊕D26⊕D27⊕D28⊕D29⊕D30⊕D31

the number of terms in the equations increases rapidly with increasing parity coverage. However, there are shared terms that help to reduce the number of gates required to implement the formulae.

In a variation of the embodiment described, multiple errors may be detected and corrected. Although such embodiments will not be described in detail, a brief overview of the requirements for such a system will be given, but reference to any of the numerous references on Hamming codes should be made for detailed implementation. The Hamming distance between two words is defined as the number of positions in which the words differ. In order to detect all patterns having d or fewer errors, a minimum Hamming distance between code words is to be (d+1). In order to correct all patterns having d or fewer errors, a minimum Hamming distance between code words is to be (2d+1). In the example above of single bit error correction, d is equal to 1 and the minimum Hamming distance between words is to be a minimum of 3. In order to correct two bit errors, a minimum Hamming distance of 5 would be used and the number of parity bits for a given number of data bits as well as the formulae calculated accordingly.

Application of the present invention to data processing systems may have some of the following advantages over prior art systems:

(i) system availability is increased due to the ability to tolerate a level of errors in data transmission;

(ii) with appropriate choice of algorithms, multiple errors such as solder shorts may be tolerated;

(iii) error correction is performed asynchronously, that is without additional clock cycles;

(iv) intermittent connections in items such as connectors and solder joints may be tolerated;

(v) general applicability to all ASIC design and extension to system-system interconnections;

(vi) may be implemented as a standard silicon design module;

(vii) warranty costs may be reduced, especially the cost of No Defect Found (NDF) due to intermittent connections;

(viii) error correction and detection can be embedded into system management architecture;

(ix) yields may be improved as some open circuit connections caused by poor solder joints can be ignored; and

(x) additional functional test coverage can be obtained.

Not all of the above benefits may be achieved in all systems, or even in any systems, as some of the benefits could be regarded as increasing the range of trade-offs available between the benefits obtained.

The present invention is particularly applicable to pervasive computing, computer servers and to personal computers. However, application is not restricted to theses categories of equipment other than the including of encoding and decoding circuitry at either end of a protected interface.

Miniaturized computing platforms such as Personal Digital Assistants (PDAs) need to operate in a stressful environment where they are exposed to shock, vibration and the like. Any technology that improves fault tolerance and increases reliability is a marketable advantage. A particularly significant cost advantage is the potential for reduced warranty costs.

High-end computer server architectures typically aim for 99.999% availability and achieve this in part through hardware redundancy and clustering. At present, this is seen as one barrier to high-end market penetration for Intel-based servers. One dependency is hardware reliability. The present invention reduces susceptibility to hard faults and to intermittent faults.

Warranty costs are high in the high-performance server market and in the high volume personal computer marketplace. Much of this is driven by manufacturing defects (for example, solder open circuit connections and intermittent connections), especially those manufacturing defects induced by mating connectors. Problems arising on signal lines protected by this method are transparent to the end-user, reducing servicing costs directly.

While the preferred embodiments have been described here in detail, it will be clear to those skilled in the art that many variants are possible without departing from the spirit and scope of the present invention.

The present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

What is claimed is:

1. A method of providing error detection and correction in an interface between two portions of a data processing system, the method comprising:
generating, in a first portion of the data processing system, parity bits corresponding to substantially the entirety of bits contained in the interface;
transmitting across the interface the parity bits together with the entirety of bits contained in the interface;
testing, in a second portion of the data processing system, that the parity bits correspond to the bits for which parity was encoded; and
detecting and correcting, in a second portion of the data processing system, errors in the bits for which parity was encoded.

2. The method according to claim 1 wherein the interface is a connector.

3. The method according to claim 1 wherein the interface includes data, address and control signals.

4. The method according to claim 1 wherein an indication is provided to the data processing system of corrected errors.

5. The method according to claim 1 wherein an indication is provided to the data processing system of uncorrected errors.

6. The method according to claim 1 wherein single bit errors are detected and corrected.

7. A system for error detection and correction in an interface between two portions of a data processing system, the system comprising:
a parity generator, in a first portion of the data processing system, for generating parity bits corresponding to substantially the entirety of bits contained in the interface;
an interface for transmitting the data bits and the parity bits;
a parity checker, in a second portion of the data processing system, for checking that the parity bits correspond to the bits for which parity was encoded; and
an error correction circuit, in a second portion of the data processing system, for correcting errors in the bits for which parity was encoded.

8. The system according to claim 7 wherein the interface is a connector.

9. The system according to claim 7 wherein the interface includes data, address and control signals.

10. The system according to claim 7 wherein an indication is provided to the data processing system of corrected errors.

11. The system according to claim 7 wherein an indication is provided to the data processing system of uncorrected errors.

12. The method according to claim 7 wherein single bit errors are detected and corrected.
